(19) United States
(12) Patent Application Publication
(10) Pub. No.: US 2025/0026225 A1
(43) Pub. Date: Jan. 23, 2025

(54) CONTROL DEVICE

(71) Applicant: SUBARU CORPORATION, Tokyo (JP)

(72) Inventor: Satoru ETO, Tokyo (JP)

(21) Appl. No.: 18/906,353

(22) Filed: Oct. 4, 2024

Related U.S. Application Data
(63) Continuation of application No. PCT/JP2023/025035, filed on Jul. 5, 2023.

(51) Int. Cl. B60L 53/62; B60R 16/033; H02J 7/00

(52) U.S. Cl. CPC B60L 53/62; B60R 16/033; H02J 7/0048

(57) ABSTRACT

A control device includes one or more processors and one or more memories. The one or more memories are coupled to the one or more processors. The one or more processors are configured to execute processing including performing indication processing of indicating charging modes having respective target remaining capacities that are different from each other, each of the target remaining capacities being a target value of a remaining capacity of a battery of a vehicle at completion of charging of the battery, simultaneously indicating, in the indication processing, the target remaining capacities in the charging modes and respective charging times in the charging modes, and performing charging of the battery in a charging mode selected by a driver who drives the vehicle from among the charging modes.

### CROSS-REFERENCE TO RELATED APPLICATIONS

This application is continuation of International Application No. PCT/JP2023/025035, filed on Jul. 5, 2023, the entire contents of which are hereby incorporated by reference.

### BACKGROUND

The disclosure relates to a control device.

There is a vehicle such as an electric vehicle or a hybrid vehicle including a drive motor as a driving source. Such a vehicle is provided with a battery that stores electric power to be supplied to the drive motor. In some cases, a battery of a vehicle can be charged by using a charger of a charging station. In charging using a charger, for example, as disclosed in Japanese Unexamined Patent Application Publication No. 2011-199920, a battery is charged with electric power supplied from the charger in a state where a cable of the charger is coupled to an inlet of the vehicle.

### SUMMARY

An aspect of the disclosure provides a control device including one or more processors and one or more memories. The one or more memories are coupled to the one or more processors. The processor is configured to execute processing including performing indication processing of indicating charging modes having respective target remaining capacities that are different from each other, each of the target remaining capacities being a target value of a remaining capacity of a battery of a vehicle at completion of charging of the battery, simultaneously indicating, in the indication processing, the target remaining capacities in the charging modes and respective charging times in the charging modes, and performing charging of the battery in a charging mode selected by a driver who drives the vehicle from among the charging modes.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic diagram illustrating a schematic configuration of a charging system according to an embodiment of the disclosure;

FIG. 2 is a block diagram illustrating an example of a functional configuration of a control device of a vehicle according to the embodiment of the disclosure;

FIG. 3 is a block diagram illustrating an example of a functional configuration of a control device of a charging station according to the embodiment of the disclosure;

FIG. 4 is a flowchart illustrating an example of a flow of a process that is performed by the control device for the vehicle according to the embodiment of the disclosure.

FIG. 5 is a diagram illustrating a first display example in indication processing according to the embodiment of the disclosure.

FIG. 6 is a graph illustrating a second display example in the indication processing according to the embodiment of the disclosure.

### DETAILED DESCRIPTION

In charging of a battery using a charger, a user needs to perform an operation for setting, for example, a target remaining capacity that is a target value of the remaining capacity of the battery at completion of the charging. It is desired to facilitate such a user operation in charging of a battery.

It is desirable to provide a control device capable of facilitating a user operation in charging of a battery.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### <Configuration of Charging System>

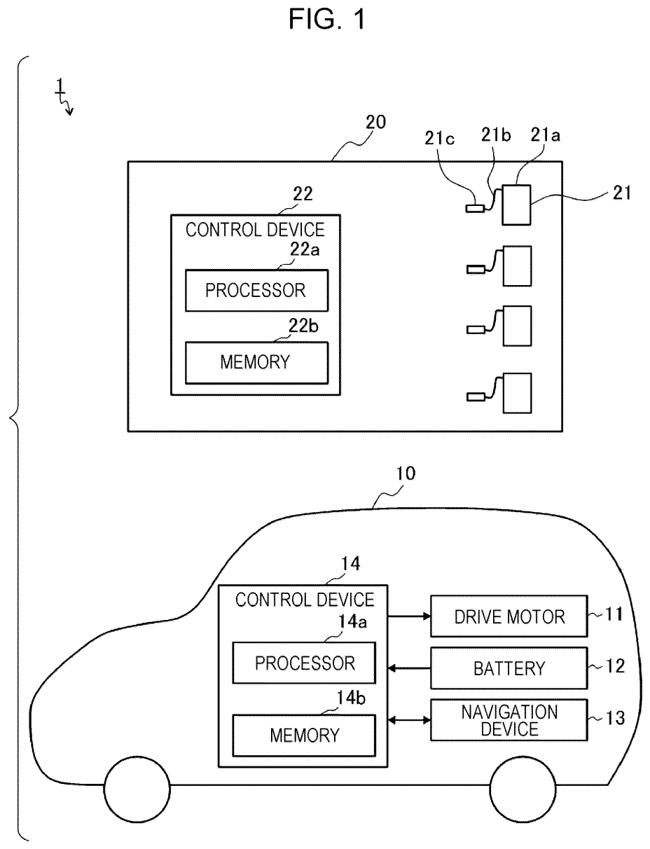

A configuration of a charging system 1 according to the embodiment of the disclosure will be described with reference to FIG. 1 to FIG. 3.

FIG. 1 is a schematic diagram illustrating the schematic configuration of the charging system 1. As illustrated in FIG. 1, the charging system 1 includes a vehicle 10 and a charging station 20.

Note that, although the single charging station 20 is illustrated in FIG. 1 for ease of understanding, the charging system 1 actually includes a plurality of the charging stations 20.

As illustrated in FIG. 1, the vehicle 10 includes a drive motor 11, a battery 12, a navigation device 13, and a control device 14. For example, the vehicle 10 is an electric vehicle that includes the drive motor 11 as a driving source. However, the vehicle 10 may be a hybrid vehicle that includes an engine as a driving source in addition to the drive motor 11.

The drive motor 11 outputs power to be transmitted to wheels of the vehicle 10 and is, for example, a three-phase alternating-current motor. The drive motor 11 is driven by electric power of the battery 12 so as to output the power.

The battery 12 can charge and discharge electric power. As the battery 12, for example, a lithium ion battery, a lithium ion polymer battery, a nickel-metal hydride battery, a nickel-cadmium battery, or a lead-acid battery is used. However, a battery different from these may be used. The battery 12 stores electric power to be supplied to the drive motor 11.

The navigation device 13 is a device that provides a driving route from a current location of the vehicle 10 to a destination desired by a user in response to an input operation performed by a driver who drives the vehicle 10. The navigation device 13 has a function of visually displaying information and displays various items of information relating to providing a route. Examples of the items of information displayed by the navigation device 13 include the current location of the vehicle 10, a driving route to be provided, the position of a destination, the distance from the current location of the vehicle 10 to the destination on the driving route, an arrival time to the destination, and so forth. The navigation device 13 can acquire information indicating the current location of the vehicle 10 based on a signal transmitted from a global positioning system (GPS) satellite.

The control device 14 corresponds to an example of a control device according to the disclosure. The control device 14 includes one or more processors 14a and one or more memories 14b coupled to the one or more processors 14a. The one or more processors 14a include, for example, a central processing unit (CPU). The one or more memories 14b include, for example, a read only memory (ROM), a random access memory (RAM), and the like. The ROM is a memory device that stores programs, operation parameters, and the like used by the CPU. The RAM is a memory device that temporarily stores data such as variables, parameters, and the like used for processing that is performed by the CPU.

The control device 14 communicates with each device included in the vehicle 10. Communication between the control device 14 and each device is performed by using, for example, controller area network (CAN) communication.

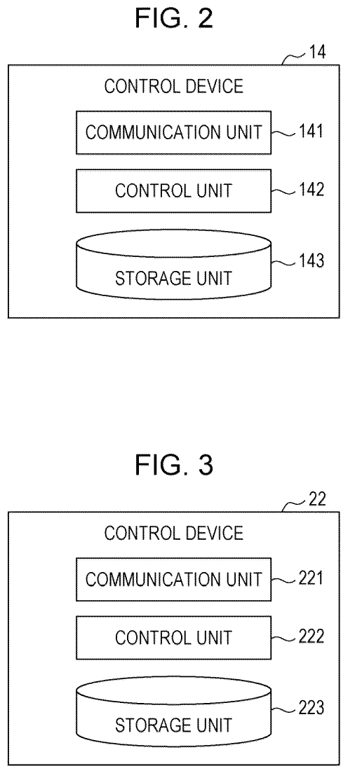

FIG. 2 is a block diagram illustrating an example of a functional configuration of the control device 14 of the vehicle 10. For example, as illustrated in FIG. 2, the control device 14 includes a communication unit 141, a control unit 142, and a storage unit 143.

Note that various processing operations including processing operations that are performed by the communication unit 141 or the control unit 142 and that will be described below may be performed by the one or more processors 14a. More specifically, the one or more processors 14a run the programs stored in the one or more memories 14b, thereby performing the various processing operations. The function of the storage unit 143 is realized by the one or more memories 14b. However, the functions of the control device 14 may be divided among a plurality of devices, and a plurality of functions may be realized by a single device.

The communication unit 141 communicates with control devices 22 (described later) of the charging stations 20. Communication between the communication unit 141 and each of the control devices 22 is realized by, for example, wireless communication.

The control unit 142 performs various processing operations for controlling the operation of each device in the vehicle 10. For example, the control unit 142 controls the operation of the drive motor 11. For example, the control unit 142 acquires various items of information such as a remaining capacity from the battery 12. For example, the control unit 142 controls the operation of the navigation device 13.

The storage unit 143 stores various items of information. The information stored in the storage unit 143 is used in the processing operations performed by the communication unit 141 or the control unit 142. For example, the communication unit 141 transmits the information stored in the storage unit 143. For example, the control unit 142 controls the operation of each device in the vehicle 10 by using the information stored in the storage unit 143.

As illustrated in FIG. 1, the charging station 20 includes a plurality of chargers 21 and one of the control devices 22. The battery 12 of the vehicle 10 is charged at the charging station 20.

The chargers 21 are each a device for charging the battery 12 of the vehicle 10. Each of the chargers 21 includes a main body 21a, a charging cable 21b, and a charging gun 21c. The main body 21a is installed in the charging station 20 and receives electric power supplied from a power supply source (not illustrated). The charging gun 21c is coupled to the main body 21a by the charging cable 21b. When the charging gun 21c is attached to an inlet of the vehicle 10, the charging cable 21b is electrically coupled to the inlet of the vehicle 10. In this state, electric power can be supplied from the main body 21a to the battery 12 of the vehicle 10 via the charging cable 21b. As a result, the battery 12 is charged.

The control device 22 includes one or more processors 22a and one or more memories 22b coupled to the one or more processors 22a. The one or more processors 22a include, for example, a CPU. The one or more memories 22b include, for example, a ROM, a RAM, and the like.

FIG. 3 is a block diagram illustrating an example of a functional configuration of the control device 22 of the charging station 20. For example, as illustrated in FIG. 3, the control device 22 includes a communication unit 221, a control unit 222, and a storage unit 223.

Note that various processing operations including the processing operations that are performed by the communication unit 221 or the control unit 222 and that will be described below may be performed by the one or more processors 22a. More specifically, the one or more processors 22a run the programs stored in the one or more memories 22b, thereby performing the various processing operations. The function of the storage unit 223 is realized by the one or more memories 22b. However, the functions of the control device 22 may be divided among a plurality of devices, and a plurality of functions may be realized by a single device.

The communication unit 221 communicates with the control device 14 of the vehicle 10. Communication between the communication unit 221 and the control device 14 is realized by, for example, wireless communication.

The control unit 222 performs various processing operations for controlling the operation of each device included in the charging station 20. For example, the control unit 222 controls the operations of the chargers 21.

The storage unit 223 stores various items of information. The information stored in the storage unit 223 is used in the processing operations performed by the communication unit 221 or the control unit 222. For example, the communication unit 221 transmits information stored in the storage unit 223. For example, the control unit 222 controls the operation of each device in the charging station 20 by using the information stored in the storage unit 223.

### <Operation of Charging System>

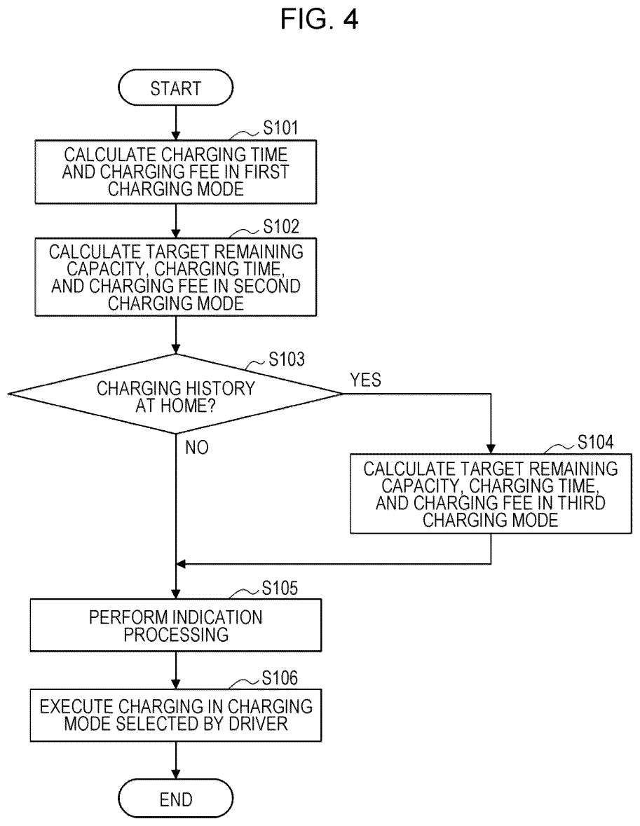

Operation of the charging system 1 according to the embodiment of the disclosure will now be described with reference to FIG. 4 to FIG. 6.

As described above, the battery 12 of the vehicle 10 is charged at the charging station 20 by using one of the chargers 21. Here, in the charging of the battery 12 using the charger 21, the driver of the vehicle 10, who is the user, needs to perform an operation for setting, for example, a target remaining capacity that is a target value of the remaining capacity of the battery 12 at completion of the charging. In the charging system 1 according to the present embodiment, by devising a process relating to a setting of charging of the battery 12 performed by the control device 14 of the vehicle 10, an operation that is performed by the user in the charging of the battery 12 can be facilitated.

FIG. 4 is a flowchart illustrating an example of a flow of the process that is performed by the control device 14 of the vehicle 10.

A control flow illustrated in FIG. 4 is executed in a situation where the battery 12 of the vehicle 10 is charged at one of the charging stations 20. More specifically, the control flow illustrated in FIG. 4 is started when one of the charging guns 21c is attached to the inlet of the vehicle 10 and the corresponding charging cable 21b is coupled to the inlet.

As will be described later, the control unit 142 of the control device 14 performs indication processing of indicating a plurality of charging modes. When the driver selects a charging mode from the plurality of charging modes, charging of the battery 12 is performed in the selected charging mode. Here, in the indication processing, the control unit 142 indicates the plurality of charging modes. In the plurality of charging modes, the target remaining capacities, each of which is a target value of the remaining capacity of the battery 12 of the vehicle 10 at the time of completion of charging of the battery 12, are different from each other. A case where the control unit 142 indicates three charging modes that are a first charging mode, a second charging mode, and a third charging mode in the indication processing will be mainly described below. However, as will be described later, the number and types of the charging modes are not limited to those in the case described below.

When the control flow illustrated in FIG. 4 is started, first, in step S101, the control unit 142 calculates a charging time and a charging fee in the first charging mode. The charging time in the first charging mode is the total time taken to charge the battery 12 in the first charging mode. The charging fee in the first charging mode is the total fee for charging the battery 12 in the first charging mode.

The first charging mode is a charging mode in which the target remaining capacity is set to a maximum remaining capacity. The maximum remaining capacity is a maximum value of the remaining capacity of the battery 12. Therefore, the remaining capacity of the battery 12 is restored to the maximum remaining capacity by charging the battery 12 in the first charging mode.

For example, the control device 14 of the vehicle 10 acquires information relating to the power supply capability of one of the chargers 21 of the charging station 20 from the control device 22 of the charging station 20. An example of such information is information indicating the amount of electric power supplied per unit time from the charger 21 of the charging station 20. Information relating to the specifications of the battery 12 is stored beforehand in the storage unit 143 of the control device 14. An example of such information is information indicating the relationship between the amount of electric power supplied per unit time to the battery 12 and the progression of the remaining capacity of the battery 12.

The control unit 142 can calculate the charging time in the first charging mode on the basis of, for example, the information relating to the power supply capability of the charger 21 and the information relating to the specifications of the battery 12. In addition, the control device 14 of the vehicle 10 acquires information indicating a charging fee per unit amount of power supplied at the charging station 20 from the control device 22 of the charging station 20. Then, the control unit 142 can calculate the charging fee in the first charging mode on the basis of, for example, information indicating a usage fee per unit time of the charger 21 and the charging time in the first charging mode.

Next, in step S102, the control unit 142 calculates a target remaining capacity, a charging time, and a charging fee in the second charging mode. The charging time in the second charging mode is the total time taken to charge the battery 12 in the second charging mode. The charging fee in the second charging mode is the total fee for charging the battery 12 in the second charging mode.

The second charging mode is a charging mode in which the target remaining capacity is set to a typical value of the remaining capacity at the time of completion of charging of the battery 12 in the past. In particular, in the case illustrated in FIG. 4, the target remaining capacity in the second charging mode is a typical value of the remaining capacity at the time of completion of charging of the battery 12 in the charging station 20 in the past. Therefore, by charging the battery 12 in the second charging mode, the remaining capacity of the battery 12 is restored to the typical value of the remaining capacity at the time of completion of charging of the battery 12 in the charging station 20 in the past.

For example, when the battery 12 is charged at the charging station 20, the driver can manually set the target remaining capacity. For example, the control unit 142 calculates, as the target remaining capacity in the second charging mode, an average value of the remaining capacities at the time of completion of a plurality of instances of charging of the battery 12 in the charging station 20 in the past. However, the control unit 142 may calculate, as the target remaining capacity in the second charging mode, a value that is larger or smaller than the average value of the remaining capacities at the time of completion of a plurality of instances of charging of the battery 12 in the charging station 20 in the past.

Similar to the case of calculating the charging time in the first charging mode, the control unit 142 can calculate the charging time in the second charging mode on the basis of, for example, the information relating to the power supply capability of the charger 21, the information relating to the specifications of the battery 12, and the target remaining capacity in the second charging mode. In addition, similar to the case of calculating the charging fee in the first charging mode, the control unit 142 can calculate the charging fee in the second charging mode on the basis of, for example, the information indicating the usage fee per unit time of the charger 21 and the charging time in the second charging mode.

Next, in step S103, the control unit 142 determines whether there is a charging history of the battery 12 at home.

In the above description, the charging station 20 has been described as a place where the battery 12 is charged. However, the driver of the vehicle 10 may sometimes be able to charge the battery 12 at home. For example, if the charger 21 is installed at home, the battery 12 can be charged by using the charger 21. Note that, in the charging using the charger 21 at home, although the charging speed is lower than that in the charging using the charger 21 of the charging station 20, which is a place different from the home, the charging fee is lower in many cases.

When the battery 12 is charged at home, for example, a charging history of the battery 12 at home is stored in the storage unit 143 of the control device 14. Thus, the control unit 142 can determine whether there is a charging history of the battery 12 at home by, for example, referring to the information stored in the storage unit 143. When there is a charging history of the battery 12 at home, it can be determined that the battery 12 can be charged at home. In contrast, when there is no charging history of the battery 12 at home, it can be determined that the battery 12 cannot be charged at home.

If it is determined that there is a charging history of the battery 12 at home (YES in step S103), the process proceeds to step S104. If it is determined that there is no charging history of the battery 12 at home (NO in step S103), the process proceeds to step S105.

If the determination result in step S103 is YES, the control unit 142 calculates a target remaining capacity, a charging time, and a charging fee in the third charging mode in step S104. The charging time in the third charging mode is the total time taken to charge the battery 12 in the third charging mode. The charging fee in the third charging mode is the total fee for charging the battery 12 in the third charging mode.

The third charging mode is a charging mode in which the target remaining capacity is set to a remaining capacity required for the vehicle 10 to travel from the charging station 20 to the home. Thus, by charging the battery 12 in the third charging mode, the remaining capacity of the battery 12 is restored to the remaining capacity required for the vehicle 10 to travel from the charging station 20 to the home.

For example, the control unit 142 calculates a travel distance from the charging station 20 that is the current location of the vehicle 10 to the home by using information acquired from the navigation device 13. Then, the control unit 142 calculates the remaining capacity to be consumed when the vehicle 10 travels the calculated travel distance as the target remaining capacity in the third charging mode. However, the control unit 142 may calculate a value that is larger or smaller than the remaining capacity to be consumed when the vehicle 10 travels the calculated travel distance as the target remaining capacity in the third charging mode.

Here, the control unit 142 may adjust the target remaining capacity in the third charging mode on the basis of the charging history of the battery 12 at home in the past. For example, the target remaining capacity in the third charging mode may be decreased as the average value of the remaining capacities at the time of completion of charging of the battery 12 at home in the past increases. Accordingly, the target remaining capacity in the third charging mode is decreased for the vehicle 10 with the battery 12 that is charged more in amount, so that the remaining capacity when the vehicle 10 arrives at home can be decreased.

Similar to the case of calculating the charging time in the first charging mode, the control unit 142 can calculate the charging time in the third charging mode on the basis of, for example, the information relating to the power supply capability of the charger 21, the information relating to the specifications of the battery 12, and the target remaining capacity in the third charging mode. In addition, similar to the case of calculating the charging fee in the first charging mode, the control unit 142 can calculate the charging fee in the third charging mode on the basis of, for example, the information indicating the usage fee per unit time of the charger 21 and the charging time in the third charging mode.

If the determination result in step S103 is NO, or after step S104, the control unit 142 performs the indication processing in step S105.

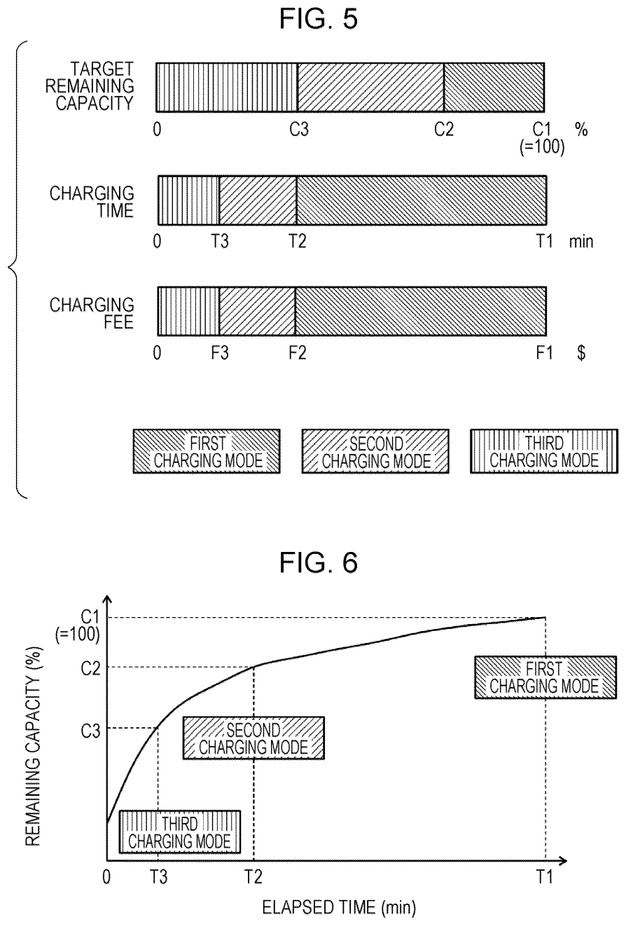

In the indication processing, for example, the control unit 142 causes the navigation device 13 to display the plurality of charging modes so as to indicate to the driver the plurality of charging modes. When step S104 is performed, the control unit 142 indicates the three charging modes, which are the first charging mode, the second charging mode, and the third charging mode, in the indication processing. When step S104 is not performed, the control unit 142 indicates the two charging modes that are the first charging mode and the second charging mode in the indication processing. A display example in the case where the three charging modes, which are the first charging mode, the second charging mode, and the third charging mode, are indicated in the indication processing will be described below with reference to FIG. 5 and FIG. 6.

FIG. 5 is a diagram illustrating a first display example in the indication processing. As illustrated in FIG. 5, in the first display example, a bar graph indicating the target remaining capacity in each charging mode, a bar graph indicating the charging time in each charging mode, and a bar graph indicating the charging fee in each charging mode are displayed in this order from the top.

In the example illustrated in FIG. 5, a target remaining capacity C1 in the first charging mode, a target remaining capacity C2 in the second charging mode, and a target remaining capacity C3 in the third charging mode, are illustrated in the uppermost bar graph indicating the target remaining capacity in each charging mode. The target remaining capacity C1 is the largest. The target remaining capacity C2 is the second largest. The target remaining capacity C3 is the third largest.

In addition, in the example illustrated in FIG. 5, a charging time T1 in the first charging mode, a charging time T2 in the second charging mode, and a charging time T3 in the third charging mode are illustrated in the second bar graph from the top, which indicates the charging time in each charging mode. The charging time T1 is the longest. The charging time T2 is the second longest. The charging time T3 is the third longest.

In the example illustrated in FIG. 5, a charging fee F1 in the first charging mode, a charging fee F2 in the second charging mode, and a charging fee F3 in the third charging mode are illustrated in the lowermost bar graph indicating the charging fee in each charging mode. The charging fee F1 is the highest. The charging fee F2 is the second highest. The charging fee F3 is the third highest.

As described above, in the example illustrated in FIG. 5, the control unit 142 indicates to the driver the target remaining capacity in each charging mode, the charging time in each charging mode, and the charging fee in each charging mode in the indication processing. This makes it easy for the driver of the vehicle 10, who is the user, to intuitively comprehend the target remaining capacity in each charging mode, the charging time in each charging mode, and the charging fee in each charging mode.

FIG. 6 is a graph illustrating a second display example in the indication processing. As illustrated in FIG. 6, in the graph in the second display example, the horizontal axis denotes elapsed time from charging starting time, and the vertical axis denotes remaining capacity. Progression of the remaining capacity of the battery 12 is indicated by a line.

In the example illustrated in FIG. 6, regarding the first charging mode, the target remaining capacity C1 in the first charging mode and the charging time T1 in the first charging mode are illustrated. The progression of the remaining capacity of the battery 12 in the first charging mode is indicated by a portion of the line indicating the progression of the remaining capacity of the battery 12, the portion extending to a point where the elapsed time reaches the charging time T1 and where the remaining capacity of the battery 12 reaches the target remaining capacity C1.

In the example illustrated in FIG. 6, regarding the second charging mode, the target remaining capacity C2 in the second charging mode and the charging time T2 in the second charging mode are illustrated. The progression of the remaining capacity of the battery 12 in the second charging mode is indicated by a portion of the line indicating the progression of the remaining capacity of the battery 12, the portion extending to a point where the elapsed time reaches the charging time T2 and where the remaining capacity of the battery 12 reaches the target remaining capacity C2.

In the example illustrated in FIG. 6, regarding the third charging mode, the target remaining capacity C3 in the third charging mode and the charging time T3 in the third charging mode are illustrated. The progression of the remaining capacity of the battery 12 in the third charging mode is indicated by a portion of the line indicating the progression of the remaining capacity of the battery 12, the portion extending to a point where the elapsed time reaches the charging time T3 and where the remaining capacity of the battery 12 reaches the target remaining capacity C3.

As described above, in the example illustrated in FIG. 6, the control unit 142 indicates to the driver the progression of the remaining capacity of the battery 12 in each charging mode in the indication processing. Note that, in the example illustrated in FIG. 6, the control unit 142 also indicates to the driver the target remaining capacity in each charging mode and the charging time in each charging mode in the indication processing, as in the example illustrated in FIG. 5. This makes it easy for the driver of the vehicle 10, who is the user, to intuitively comprehend the progression of the remaining capacity of the battery 12 in each charging mode, the target remaining capacity in each charging mode, and the charging time in each charging mode.

A case has been described above in which the control unit 142 causes the navigation device 13 to display the plurality of charging modes in the indication processing. However, the indication processing is not limited to the above case. For example, in the indication processing, the control unit 142 may cause a display device that is different from the navigation device 13 to display the plurality of charging modes. For example, in the indication processing, the control unit 142 may indicate the driver of the vehicle 10 the plurality of charging modes by audio output.

After step S105 of FIG. 4, the driver selects one charging mode the driver desires from the plurality of charging modes that have been indicated. The control device 14 receives the selection of the charging mode performed by the driver and acquires information indicating the charging mode selected by the driver. Then, in step S106, the control unit 142 executes charging of the battery 12 in the charging mode selected by the driver of the vehicle 10, and the control flow illustrated in FIG. 4 ends.

In step S106, the control unit 142 transmits, for example, a control command to the control unit 222 of the control device 22 of the charging station 20 via the communication unit 141. As a result, the control unit 142 can control the charging of the battery 12 using the charger 21. More specifically, in step S106, the control unit 142 executes charging of the battery 12 until the remaining capacity of the battery 12 reaches the target remaining capacity in the charging mode selected by the driver, and the control unit 142 terminates the charging of the battery 12 when the remaining capacity of the battery 12 reaches the target remaining capacity. In the case where the charging speed of the battery 12 can be controlled, the control unit 142 controls the charging speed of the battery 12 such that the remaining capacity of the battery 12 follows the progression in the charging mode selected by the driver.

As described above, the control device 14 performs the indication processing of indicating the plurality of charging modes, in which the target remaining capacities each of which is a target value of the remaining capacity of the battery 12 of the vehicle 10 at the time of completion of charging of the battery 12 are different from each other, and executes charging of the battery 12 in the charging mode selected by the driver of the vehicle 10 from the plurality of charging modes. As a result, the driver of the vehicle 10, who is the user, can set the target remaining capacity in charging of the battery 12 by performing a simple operation of selecting one charging mode the driver desires from the indicated plurality of charging modes. Therefore, the operation that is performed by the user in the charging of the battery 12 can be facilitated.

The example of the process performed by the control device 14 has been described above with reference to FIG. 4 to FIG. 6. However, the process performed by the control device 14 is not limited to the example described above.

For example, in the above-described example, a case has been described in which each processing illustrated of FIG. 4 including the indication processing is performed when charging of the battery 12 is performed at the charging station 20 that is different from the home. However, each processing including the indication processing may be performed when charging of the battery 12 is performed at home. In this case, for example, the target remaining capacity in the second charging mode is set to a typical value of the remaining capacity of the battery 12 at the time of completion of charging at home in the past. In addition, in this case, the proposal of the third charging mode is omitted.

For example, in the above-described example, a case has been mainly described in which the control unit 142 indicates the three charging modes, which are the first charging mode, the second charging mode, and the third charging mode, in the indication processing. However, the number and types of the charging modes are not limited to those mentioned in the above example. For example, the number of the charging modes indicated in the indication processing may be four or more. In the above-described example, the charging speeds in the plurality of charging modes indicated in the indication processing are the same as each other. However, in the plurality of charging modes indicated in the indication processing, the charging speed in at least one of the charging modes and the charging speed in at least another one of the charging modes may be different from each other. For example, in the case where the three charging modes, which are the first charging mode, the second charging mode, and the third charging mode, are indicated, the charging speed in the third charging mode may be faster than the charging speed in the first charging mode and faster than the charging speed in the second charging mode. Note that the amount of electric power supplied per unit time from the charger 21 to the battery 12 increases as the charging speed increases. In other words, the difference in charging speeds indicates that the amount of electric power supplied per unit time from the charger 21 to the battery 12 varies.

For example, in the above-described example, examples of the information to be indicated to the driver in the indication processing have been described with reference to FIG. 5 and FIG. 6. However, a combination of the items of information to be indicated to the driver in the indication processing is not limited to the above example. For example, in the indication processing, the control unit 142 may indicate to the driver only one item of information among the target remaining capacity in each charging mode, the charging time in each charging mode, the charging fee in each charging mode, and progression of the remaining capacity of the battery 12 in each charging mode. Alternatively, the control unit 142 may indicate to the driver all of these items of information. For example, in the indication processing, the control unit 142 may indicate to the driver a plurality of any of items of information selected from the target remaining capacity in each charging mode, the charging time in each charging mode, the charging fee in each charging mode, and progression of the remaining capacity of the battery 12 in each charging mode. For example, the control unit 142 may indicate to the driver another item of information other than those described above in the indication processing.

### <Effect of Charging System>

Next, effects of the charging system 1 according to the embodiment of the disclosure will be described.

In the control device 14 of the charging system 1 according to the present embodiment, the one or more processors 14a executes a process including performing indication processing of indicating the plurality of charging modes, in which the target remaining capacities each of which is a target value of the remaining capacity of the battery 12 of the vehicle 10 at the time of completion of charging of the battery 12 are different from each other, and executing charging of the battery 12 in the charging mode selected by the driver of the vehicle 10 from the plurality of charging modes. As a result, the driver of the vehicle 10, who is the user, can set the target remaining capacity in charging of the battery 12 by performing a simple operation of selecting one charging mode the driver desires from the indicated plurality of charging modes. Therefore, the operation that is performed by the user in the charging of the battery 12 can be facilitated.

In the control device 14 of the charging system 1 according to the present embodiment, it is preferable that the plurality of charging modes include the first charging mode in which the target remaining capacity is set to the maximum remaining capacity. This enables the driver of the vehicle 10, who is the user, to set the target remaining capacity in charging of the battery 12 to the maximum remaining capacity by performing a simple operation of selecting the first charging mode.

In the control device 14 of the charging system 1 according to the present embodiment, it is preferable that the plurality of charging modes include the second charging mode in which the target remaining capacity is set to a typical value of the remaining capacity at the time of completion of charging of the battery 12 in the past. This enables the driver of the vehicle 10, who is the user, to set the target remaining capacity in charging of the battery 12 to a typical value of the remaining capacity at the time of completion of charging of the battery 12 in the past by performing a simple operation of selecting the second charging mode.

In the control device 14 of the charging system 1 according to the present embodiment, it is preferable that the indication processing be executed when charging of the battery 12 is performed in one of the charging stations 20 that is different from the home, and it is preferable that the plurality of charging modes include the third charging mode in which the target remaining capacity is set to a remaining capacity required for the vehicle 10 to travel from the charging station 20 to the home. This enables the driver of the vehicle 10, who is the user, to set the target remaining capacity in charging of the battery 12 to a remaining capacity required for the vehicle 10 to travel from the charging station 20 to the home by performing a simple operation of selecting the third charging mode.

In the control device 14 of the charging system 1 according to the present embodiment, it is preferable that the one or more processors 14a execute a process including adjusting the target remaining capacity in the third charging mode on the basis of a charging history of the battery 12 at home in the past. In this case, the target remaining capacity in the third charging mode can be optimized in accordance with the charging history of the battery 12 at home in the past.

In the control device 14 of the charging system 1 according to the present embodiment, it is preferable that the charging speed in at least one of the plurality of charging modes and the charging speed in at least another one of the plurality of charging modes be different from each other. In this case, the driver of the vehicle 10, who is the user, can set the charging speed in charging of the battery 12 in addition to the target remaining capacity in the charging of the battery 12 by performing a simple operation of selecting one charging mode the driver desires from the indicated plurality of charging modes. Therefore, the operation that is performed by the user in the charging of the battery 12 can be further facilitated.

In the control device 14 of the charging system 1 according to the present embodiment, it is preferable that the one or more processors 14a execute, in the indication processing, a process including indicating the target remaining capacities of the plurality of charging mode. This makes it easy for the driver of the vehicle 10, who is the user, to intuitively comprehend the target remaining capacity in each charging mode. Comprehending the target remaining capacity in each charging mode enables the user to more easily select one of the charging modes.

In the control device 14 of the charging system 1 according to the present embodiment, it is preferable that the one or more processors 14a execute, in the indication processing, a process including indicating the charging time in each charging mode. This makes it easy for the driver of the vehicle 10, who is the user, to intuitively comprehend the charging time in each charging mode. Comprehending the charging time in each charging mode enables the user to more easily select one of the charging modes.

In the control device 14 of the charging system 1 according to the present embodiment, it is preferable that the one or more processors 14a execute, in the indication processing, a process including indicating the charging fee in each charging mode. This makes it easy for the driver of the vehicle 10, who is the user, to intuitively comprehend the charging fee in each charging mode. Comprehending the charging fee in each charging mode enables the user to more easily select one of the charging modes.

In the control device 14 of the charging system 1 according to the present embodiment, it is preferable that the one or more processors 14a execute, in the indication processing, a process including indicating progression of the remaining capacity of the battery 12 in each charging mode. This makes it easy for the driver of the vehicle 10, who is the user, to intuitively comprehend the progression of the remaining capacity of the battery 12 in each charging mode. Comprehending the progression of the remaining capacity of the battery 12 in each charging mode enables the user to more easily select one of the charging modes.

Although a preferred embodiment of the disclosure has been described above with reference to the accompanying drawings, it is obvious that the disclosure is not limited to the above-described embodiment and that various modifications or corrections within the scope described in the claims also belong to the technical scope of the disclosure.

For example, in the above description, the process executed by the control device 14 and the process executed by the control device 22 have been described in such a manner as to be distinguished from each other. However, the devices that execute the above-described processes may be suitably changed. For example, any part of the process described above as the process executed by the control device 14 may be executed by the control device 22. Any part of the process described above as the process executed by the control device 22 may be executed by the control device 14.

For example, the process described with reference to the flow chart in the present specification may not necessarily be performed in the order illustrated in the flow chart. In addition, additional processing steps may be employed, and some processing steps may be omitted.

According to the disclosure, a user operation in charging of a battery can be facilitated.

The invention claimed is:

1. A control device comprising:
one or more processors; and
one or more memories coupled to the one or more processors;
wherein the one or more processors are configured to execute processing comprising
performing indication processing of indicating charging modes having respective target remaining capacities that are different from each other, each of the target remaining capacities being a target value of a remaining capacity of a battery of a vehicle at completion of charging of the battery,
simultaneously indicating, in the indication processing, the target remaining capacities in the charging modes and respective charging times in the charging modes, and
performing charging of the battery in a charging mode selected by a driver who drives the vehicle from among the charging modes.

2. The control device according to claim 1,
wherein the charging modes comprise a first charging mode in which the target remaining capacity is set to a maximum remaining capacity.

3. The control device according to claim 1,
wherein the charging modes comprise a second charging mode in which the target remaining capacity is set to a typical value of a remaining capacity of the battery in previous times of charging completion.

4. The control device according to claim 1,
wherein the indication processing is performed when the charging of the battery is performed in a charging station different from home, and
wherein the charging modes comprise a third charging mode in which the target remaining capacity is set to a remaining capacity required for the vehicle to travel from the charging station to home.

5. The control device according to claim 4,
wherein the one or more processors are configured to execute a process comprising adjusting the target remaining capacity in the third charging mode based on a charging history of the battery at home in previous times.

6. The control device according to claim 1,
wherein a charging speed in at least one of the charging modes and a charging speed in at least another one of the charging modes are different from each other.

7. The control device according to claim 1,
wherein the one or more processors are configured to execute, in the indication processing, processing comprising indicating respective charging fees for the charging modes.

8. The control device according to claim 2,
wherein the one or more processors are configured to execute, in the indication processing, processing comprising indicating respective charging fees for the charging modes.

9. The control device according to claim 3,
wherein the one or more processors are configured to execute, in the indication processing, processing comprising indicating respective charging fees for the charging modes.

10. The control device according to claim 4,
wherein the one or more processors are configured to execute, in the indication processing, processing comprising indicating respective charging fees for the charging modes.

11. The control device according to claim 5,
wherein the one or more processors are configured to execute, in the indication processing, processing comprising indicating respective charging fees for the charging modes.

12. The control device according to claim 6,
wherein the one or more processors are configured to execute, in the indication processing, processing comprising indicating respective charging fees for the charging modes.

13. The control device according to claim 1,
wherein the one or more processors are configured to execute, in the indication processing, processing comprising indicating progression of a remaining capacity of the battery in each of the charging modes.

14. The control device according to claim 2,
wherein the one or more processors are configured to execute, in the indication processing, processing comprising indicating progression of a remaining capacity of the battery in each of the charging modes.

15. The control device according to claim 3,
wherein the one or more processors are configured to execute, in the indication processing, processing comprising indicating progression of a remaining capacity of the battery in each of the charging modes.

16. The control device according to claim 4,
wherein the one or more processors are configured to execute, in the indication processing, processing comprising indicating progression of a remaining capacity of the battery in each of the charging modes.

17. The control device according to claim 5,
wherein the one or more processors are configured to execute, in the indication processing, processing comprising indicating progression of a remaining capacity of the battery in each of the charging modes.

18. The control device according to claim 6,
wherein the one or more processors are configured to execute, in the indication processing, processing comprising indicating progression of a remaining capacity of the battery in each of the charging modes.
